(19) United States
(12) Patent Application Publication
(10) Pub. No.: US 2023/0025073 A1
(43) Pub. Date: Jan. 26, 2023

(54) UNMANNED AERIAL VEHICLE

(71) Applicant: Toyo Seikan Co., Ltd., Tokyo (JP)

(72) Inventors: Atsushi KOMINAMI, Kanagawa (JP); Souji ARAKI, Kanagawa (JP)

(21) Appl. No.: 17/787,932

(22) PCT Filed: Oct. 9, 2020
(86) PCT No.: PCT/JP2020/038393

§ 371 Date: Jun. 21, 2022

(30) Foreign Application Priority Data
Dec. 23, 2019 (JP) 2019-232049

(51) Int. Cl. B64C 39/02; B64D 1/18; B65D 83/14

(52) U.S. Cl. CPC B64C 39/024; B64D 1/18; B65D 83/753; B64C 2201/127; B64C 2201/108

(57) ABSTRACT

Provided is an unmanned aerial vehicle configured to be able to discharge a liquid, comprising: a container of the liquid; a discharging unit configured to discharge the liquid; and a coupling unit configured to couple the container and the discharging unit together, wherein the coupling unit includes a buffering unit configured to buffer stress generated in the coupling unit. The container may be an aerosol container. The coupling unit may include a rigid unit coupled to the buffering unit and configured to have rigidity higher than the buffering unit.

### BACKGROUND

### 1. Technical Field

The present invention relates to an unmanned aerial vehicle.

### 2. Related Art

Conventionally, unmanned aerial vehicles with a fluid jet nozzle are known (for example, see Patent Document 1).

### PRIOR ART DOCUMENT

### [Patent Document]

### [Patent Document 1] Japanese Patent Application Publication No. 2019-18589

### Technical Problem

In a conventional unmanned aerial vehicle, when a nozzle contacts with an obstacle, the nozzle may be damaged, or it may have an impact on the flight of the unmanned aerial vehicle.

### General Disclosure

To solve the above-mentioned issue, in the first aspect of the present invention, an unmanned aerial vehicle configured to be able to discharge a liquid is provided, which includes a container of the liquid, a discharging unit configured to discharge the liquid, and a coupling unit configured to couple the container and the discharging unit together, wherein the coupling unit includes a buffering unit configured to buffer stress generated in the coupling unit.

The container may be an aerosol container.

The coupling unit may include a rigid unit coupled to the buffering unit and configured to have rigidity higher than the buffering unit.

The buffering unit may be longer than the rigid unit, in the coupling unit.

The unmanned aerial vehicle may include a connecting unit in which one of the buffering unit and the rigid unit is inserted into the other of the buffering unit and the rigid unit.

The buffering unit may be provided closer to the container than the rigid unit, in the coupling unit.

The buffering unit may be provided closer to the discharging unit than the rigid unit, in the coupling unit.

The buffering unit may include: a tube configured to supply the liquid from the container to the discharging unit; and a supporting unit configured to support the tube.

The supporting unit may include an inlet configured to inject a gas and is configured to acquire a supporting force for the tube by encapsulating the gas.

The unmanned aerial vehicle may further include a gas supplying unit for supplying a gas to the supporting unit, wherein the gas supplying unit is configured to maintain the pressure of the supporting unit.

The gas supplying unit may be an aerosol container.

The tube may be configured to be extended by a supporting force from the supporting unit.

At least one supporting unit may be provided along a side of the tube.

The tube may be constructed by the sidewall of the supporting unit.

The summary clause does not necessarily describe all necessary features of the embodiments of the present invention. The present invention may also be a sub-combination of the features described above.

### BRIEF DESCRIPTION OF THE DRAWINGS

FIG. 1A illustrates an example of configurations of an unmanned aerial vehicle 100.

FIG. 1B illustrates stress buffering by the buffering unit 42.

FIG. 1C is an enlarged cross sectional view of the vicinity of the connecting unit 43.

FIG. 2A illustrates an example of configurations of the unmanned aerial vehicle 100.

FIG. 2B illustrates stress buffering by the buffering unit 42.

FIG. 2C is an enlarged cross sectional view of the vicinity of the connecting unit 43.

FIG. 3A illustrates an example of configurations of the unmanned aerial vehicle 100.

FIG. 3B is an enlarged perspective view illustrating the structure of the buffering unit 42.

FIG. 3C illustrates a case where the supporting unit 48 is one, as an example.

FIG. 3D illustrates an example of the tube 46 constructed by sidewalls of the supporting units 48.

FIG. 3E illustrates an example of the inlet 49 configured to inject gas into the supporting unit 48.

FIG. 4A illustrates an example of configurations of the unmanned aerial vehicle 100.

FIG. 4B is an enlarged perspective view of the vicinity of the connecting unit 43.

FIG. 4C is an enlarged cross sectional view of the vicinity of the connecting unit 43.

FIG. 5A illustrates an example of configurations of the unmanned aerial vehicle 100.

FIG. 5B is an enlarged cross sectional view of the vicinity of the gas supplying unit 80.

FIG. 6 illustrates an example of a piloting system 200 of an unmanned aerial vehicle 100.

### DESCRIPTION OF EXEMPLARY EMBODIMENTS

Hereinafter, the present invention will be described through embodiments of the invention, but the following embodiments do not limit the invention according to the claims. In addition, not all combinations of features described in the embodiments are necessarily required for solutions of the invention.

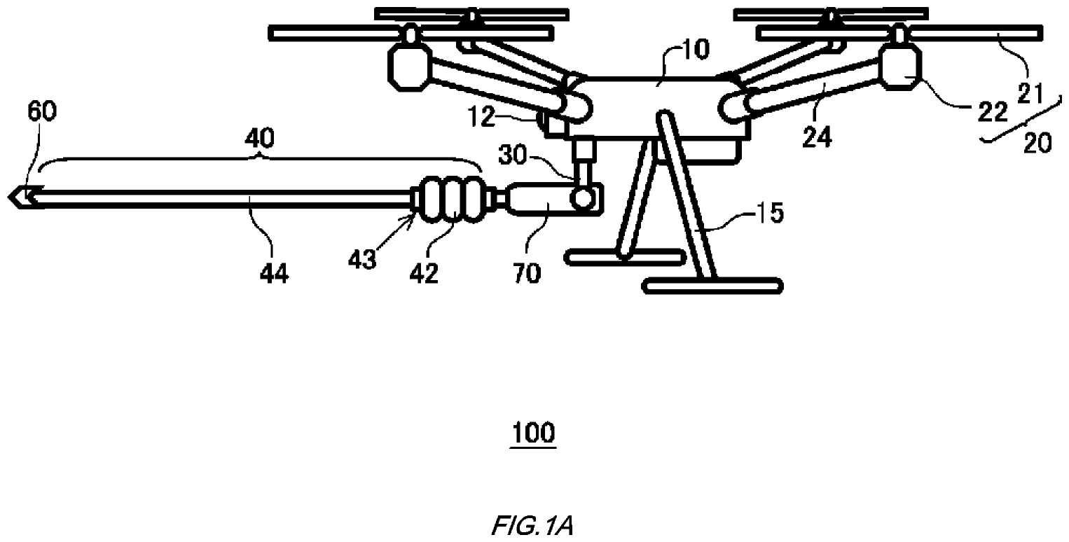

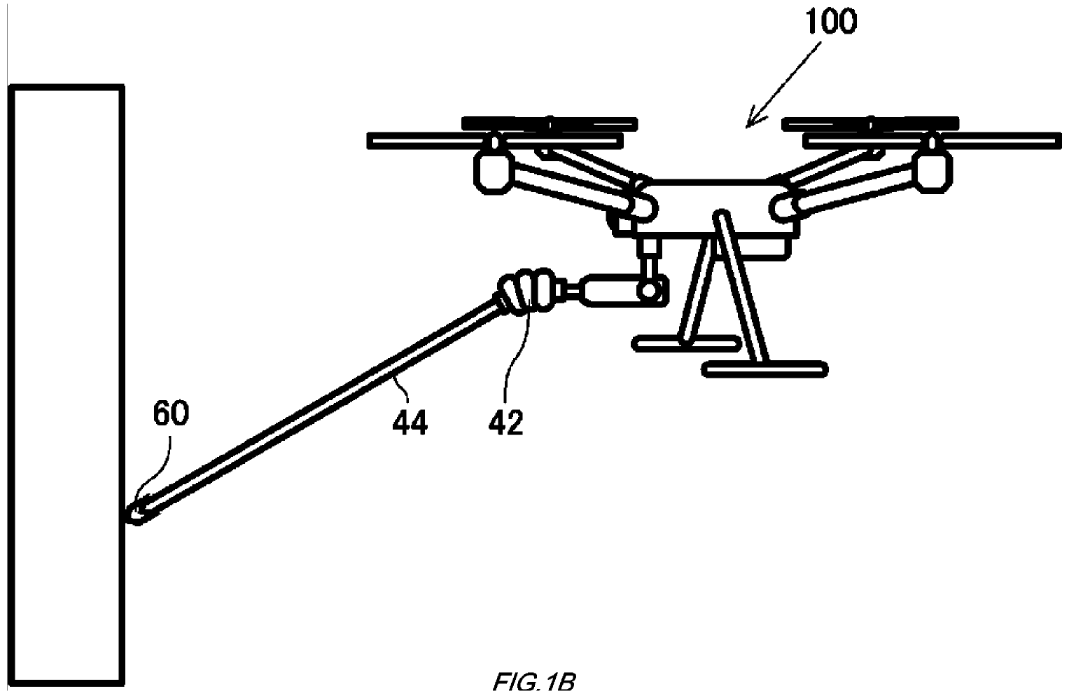

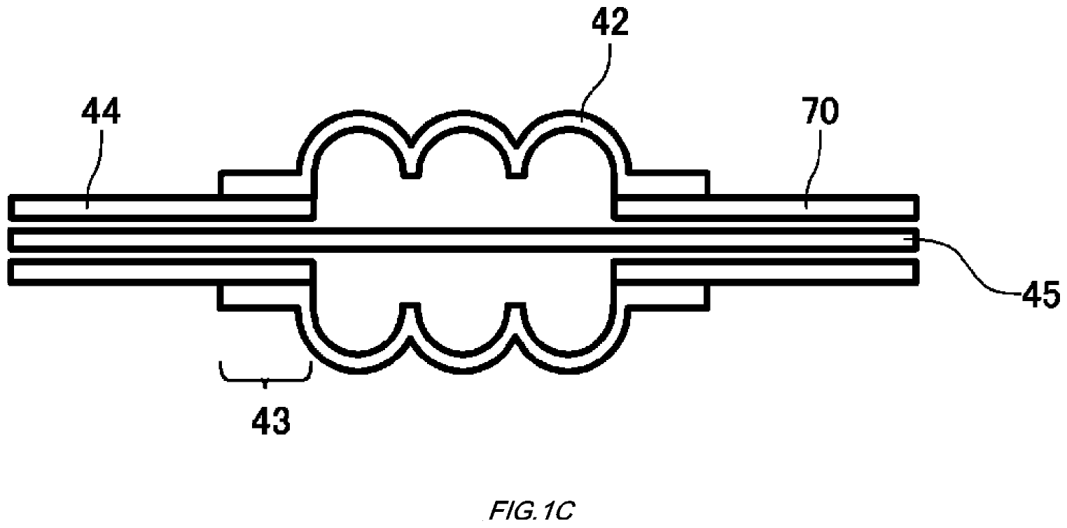

FIG. 1A illustrates an example of configurations of an unmanned aerial vehicle 100. The unmanned aerial vehicle 100 of the present example includes a body 10, a leg 15, a propelling unit 20, an arm 24, a container retaining unit 30, a coupling unit 40, and a discharging unit 60. The container retaining unit 30 retains a container 70.

The unmanned aerial vehicle 100 is a flying object configured to fly in the air. The unmanned aerial vehicle 100 is able to discharge a liquid held in the container 70.

The body 10 is configured to store various control circuits, a power supply, and the like of the unmanned aerial vehicle 100. In addition, the body 10 may function as a structure configured to couple configurations of the unmanned aerial vehicle 100 together. The body 10 of the present example is coupled to the propelling unit 20 by the arm 24.

A camera 12 is provided for the body 10 and configured to capture an image of a surrounding area of the unmanned aerial vehicle 100. The camera 12 may be a movable camera capable of changing an image-capturing direction, or may be a fixed camera which has a fixed image-capturing direction. A plurality of cameras 12 may be provided at different positions of the unmanned aerial vehicle 100. The camera 12 may capture an image for a range of discharging a liquid. In an example, a video captured by the camera 12 is sent to a terminal apparatus of the unmanned aerial vehicle 100. A person who pilots the unmanned aerial vehicle 100 may operate the unmanned aerial vehicle 100 based on the video captured by the camera 12.

The propelling unit 20 is configured to generate a propelling force for propelling the unmanned aerial vehicle 100. The propelling unit 20 includes a rotor wing 21 and a rotation driving unit 22. The unmanned aerial vehicle 100 of the present example includes four propelling units 20. The propelling unit 20 is attached to the body 10 via the arm 24. Note that the unmanned aerial vehicle 100 may be a flying object including a fixed wing as the propelling unit 20.

The rotor wing 21 is configured to generate a propelling force through rotation. Although the four rotor wings 21 are provided around the body 10, the way of arrangement is not limited to the present example. The rotor wing 21 is provided at a tip of the arm 24 via the rotation driving unit 22.

The rotation driving unit 22 has a power source such as a motor and is configured to drive the rotor wing 21. The rotation driving unit 22 may have a brake mechanism for the rotor wing 21. The rotor wing 21 and the rotation driving unit 22 may also be directly attached to the body 10, without the arm 24.

The arm 24 is provided to extend from the body 10 in a radial manner. The unmanned aerial vehicle 100 of the present example includes four arms 24 provided in correspondence to four propelling units 20. The arm 24 may be fixed or movable. To the arm 24, another configuration such as a camera may be fixed.

The leg 15 is a leg for landing, which is coupled to the body 10 to retain the posture of the unmanned aerial vehicle 100 when landing. The leg 15 retains the posture of the unmanned aerial vehicle 100 with the propelling unit 20 stopped. The unmanned aerial vehicle 100 of the present example has two legs 15, which is not limiting.

The container retaining unit 30 is configured to retain the container 70 and couple the container 70 and the body 10 together. The container retaining unit 30 may be coupled to a member other than the body 10, such as the arm 24 or the leg 15. The container retaining unit 30 may be able to change the orientation of the container 70. The container retaining unit 30 may be a gimbal for controlling the position of the container 70 in triaxial directions. In an example, the container retaining unit 30 adjusts the discharge direction of the discharging unit 60 by changing the position of the container 70.

The container 70 is a container configured to hold a liquid. In an example, the container 70 is an aerosol container. The aerosol container is configured to eject a liquid by gas pressure of liquefied gas or compressed gas filling the inside. Although the container 70 of the present example is an aerosol can made of metal, the container 70 may be a plastic container having resistance to pressure. Note that as propellants, liquefied gas, such as hydrocarbon (liquefied petroleum gases) (LPG), dimethyl ether (DME), or fluorohydrocarbon (HFO-1234ze), or compressed gas, such as carbon dioxide (CO₂), nitrogen (N₂), nitrous oxide (N₂O), may be used.

The coupling unit 40 is configured to couple the container 70 and the discharging unit 60 to distribute the liquid ejected from the container 70 to the discharging unit 60. The coupling unit 40 may be extended toward the discharge direction of the discharging unit 60. Even when, for example, there exists an obstacle in the surrounding area of a target location to which a liquid is discharged, and the unmanned aerial vehicle 100 cannot approach the target location, providing enough long coupling unit 40 enables relatively precisely performing the discharge to the target location.

The coupling unit 40 has a buffering unit 42 configured to buffer the stress generated in the coupling unit 40. For example, the buffering unit 42 buffers the stress by deforming in accordance with the stress generated in the coupling unit 40. The buffering unit 42 may be allowed to deform by the flexibility of the material itself of the buffering unit 42, or may have a shape or structure which can deform. After the buffering unit 42 has deformed because of the stress to the coupling unit 40, and the stress was relieved, the shape and the dimension of the buffering unit 42 may return to those before undergoing the stress. The buffering unit 42 of the present example has a bellows structure which allows stretching and bending.

The coupling unit 40 may further have a rigid unit 44 coupled to the buffering unit 42. The buffering unit 42 and the rigid unit 44 are coupled together via a connecting unit 43. The connecting unit 43 will be specifically described later. The rigid unit 44 has rigidity higher than the buffering unit 42. The material of the rigid unit 44 may be metal, or hard material such as plastic. The rigid unit 44 of the present example has an approximately cylinder shape, the inside of which is hollow. In the coupling unit 40 of the present example, the buffering unit 42 is provided closer to the container 70 than the rigid unit 44.

The discharging unit 60 is coupled to the container 70 via the coupling unit 40 to discharge the liquid held in the container 70. For example, the discharging unit 60 is a nozzle for discharging the liquid. The discharging unit 60 may be designed such that the liquid is discharged in a mist form or foam form.

The discharging unit 60 may discharge the liquid in a radial manner, or may discharge the liquid in a linear manner.

FIG. 1B illustrates stress buffering by the buffering unit 42. As illustrated in FIG. 1B, while the unmanned aerial vehicle 100 is flying, if the discharging unit 60 contacts with an obstacle such as a wall, the buffering unit 42 bends by stretching of the bellows. Thus, the stress generated in the coupling unit 40 because of the contact with the obstacle can be buffered, and the coupling unit 40 can be prevented from being damaged. In addition, this can suppress the transmission of the stress because of the contact with the obstacle to the body of the unmanned aerial vehicle 100 via the coupling unit 40, and can prevent the flight of the unmanned aerial vehicle 100 from being impacted. Therefore, even when the coupling unit 40 is long and easy to contact with an obstacle, the impact on the unmanned aerial vehicle 100 because the contact can be suppressed.

FIG. 1C is an enlarged cross sectional view of the vicinity of the connecting unit 43. In the connecting unit 43, one of the buffering unit 42 or the rigid unit 44 is inserted to the other so that the buffering unit 42 and the rigid unit 44 are connected to each other. In the connecting unit 43 of the present example, the rigid unit 44 is inserted to the buffering unit 42. For example, an end of the buffering unit 42 is formed of stretch material, and the rigid unit 44 is pushed and inserted into an end of the buffering unit 42. As another example, screw machining of ends of the buffering unit 42 and the rigid unit 44 may be executed to thrust and insert one of them into the other. After the buffering unit 42 and the rigid unit 44 are connected by the inserting, they may further be joined together by means of glue, welding, or the like.

Note that as illustrated in FIG. 1C, an area where the buffering unit 42 and the rigid unit 44 overlap in a direction perpendicular to the direction in which the coupling unit 40 extended may be considered as the connecting unit 43. In addition, although the container 70 is connected to the end of the buffering unit 42 on the side opposite to the rigid unit 44 in the present example, the container 70 as well as the rigid unit 44 may be inserted into the buffering unit 42.

As illustrated in FIG. 1C, an internal stream tube 45 configured to distribute a liquid inside the coupling unit 40 may be provided. One end of the internal stream tube 45 of the present example is connected to the container 70, and the other end is connected to the discharging unit 60 to distribute the liquid from the container 70 to the discharging unit 60, inside the buffering unit 42 and the rigid unit 44. In the present example, the internal stream tube 45 may be made of soft material, and for example, when the coupling unit 40 contacts with an obstacle, the internal stream tube 45 may bend together with the buffering unit 42. Note that, without providing the internal stream tube 45, the buffering unit 42 and the rigid unit 44 themselves may be used as a flow channel of the liquid.

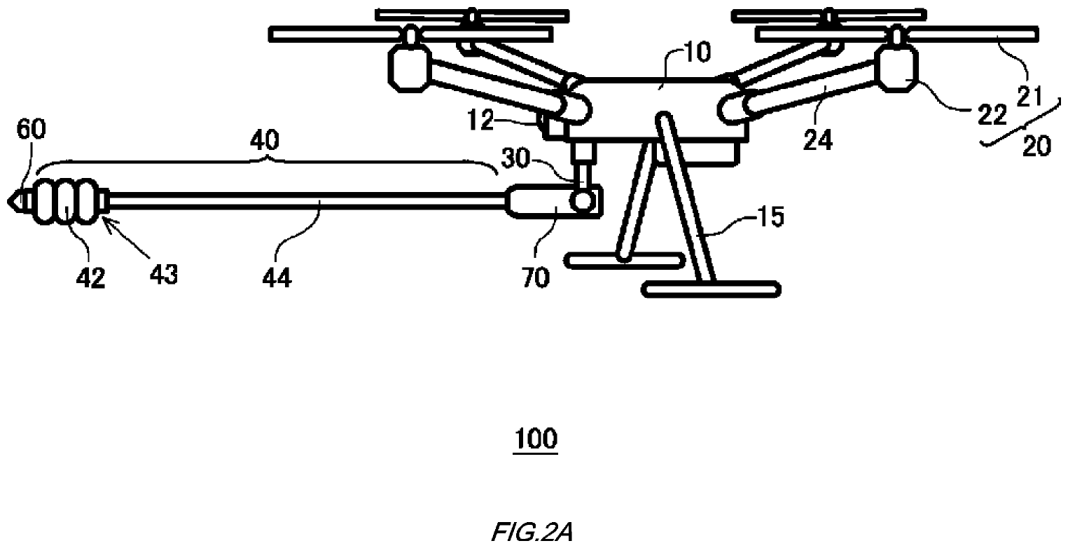

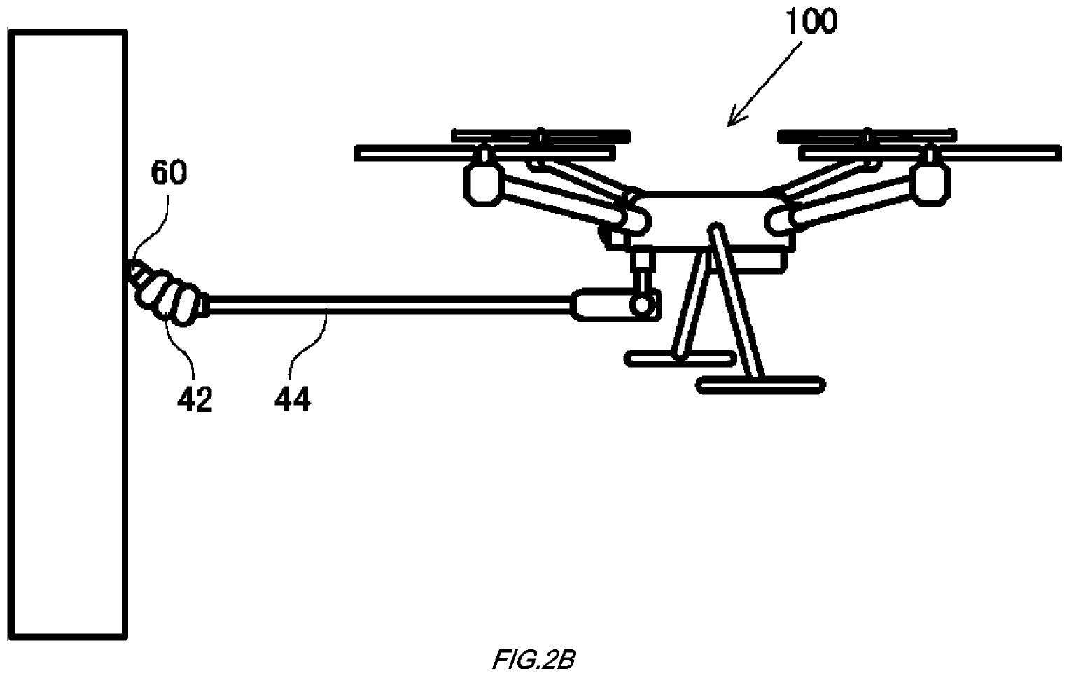

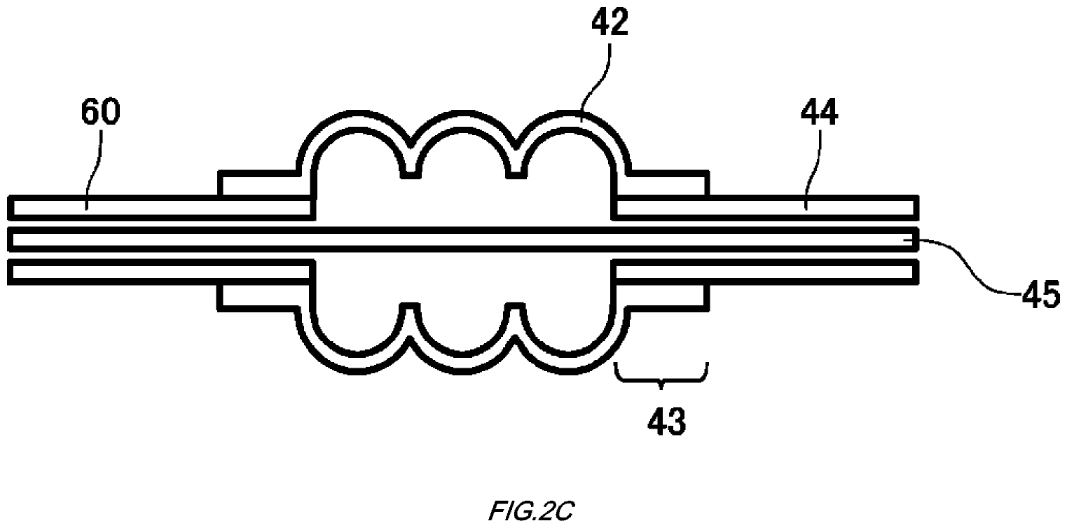

FIG. 2A illustrates an example of configurations of the unmanned aerial vehicle 100. The unmanned aerial vehicle 100 of the present example is the same as the example of FIG. 1A except for configurations of the coupling unit 40. In the coupling unit 40 of the present example, the buffering unit 42 is provided closer to the discharging unit 60 than the rigid unit 44.

FIG. 2B illustrates stress buffering by the buffering unit 42. As illustrated in FIG. 2B, while the unmanned aerial vehicle 100 is flying, if the discharging unit 60 contacts with an obstacle, the buffering unit 42 bends by stretching of the bellows. With such an arrangement of the present example, the stress generated in the coupling unit 40 because of the contact with the obstacle can also be buffered, and the impact on the flight of the unmanned aerial vehicle 100 because of the contact can be suppressed. In addition, by arranging the buffering unit 42 closer to the discharging unit 60 than the rigid unit 44, the transmission of the stress because of the contact with the obstacle to the rigid unit 44 can be suppressed, and thus the coupling unit 40 can further be prevented from being damaged.

FIG. 2C is an enlarged cross sectional view of the vicinity of the connecting unit 43. In the connecting unit 43 of the present example as well as the example illustrated in FIG. 1C, the rigid unit 44 is inserted to the buffering unit 42. In addition, although the discharging unit 60 is connected to the end of the buffering unit 42 on the side opposite to the rigid unit 44 in the present example, the discharging unit 60 as well as the rigid unit 44 may be inserted into the buffering unit 42.

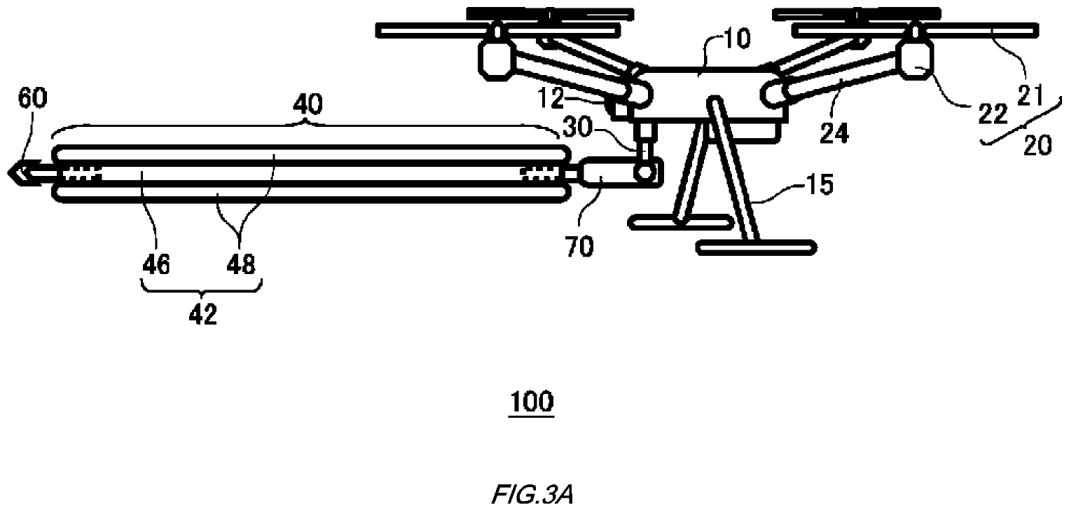

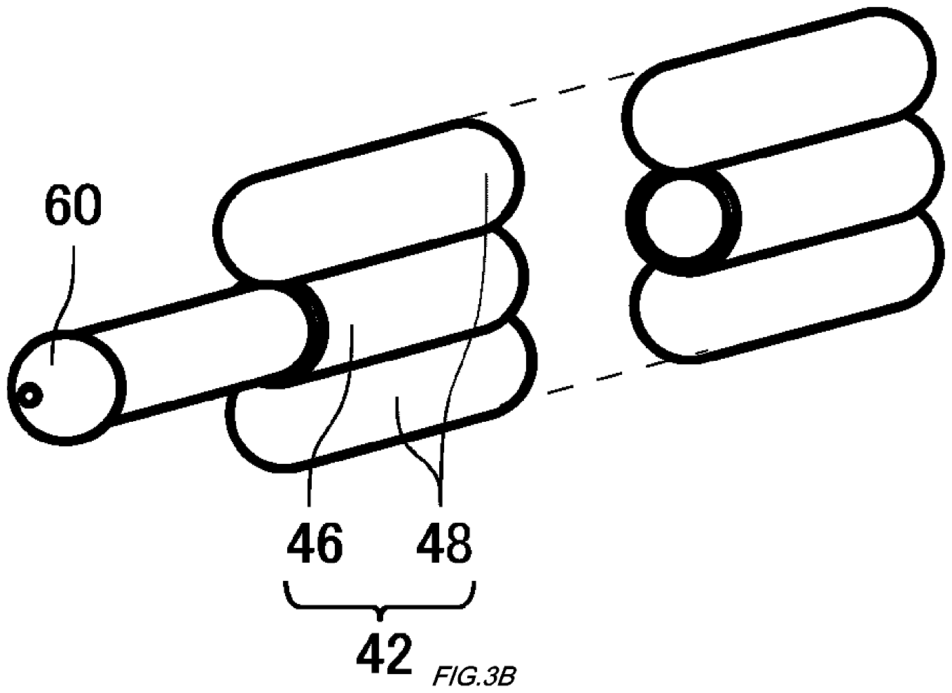

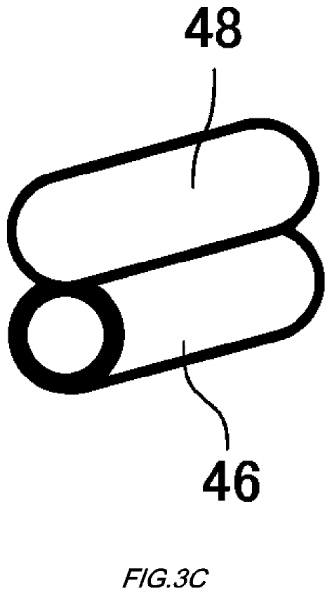

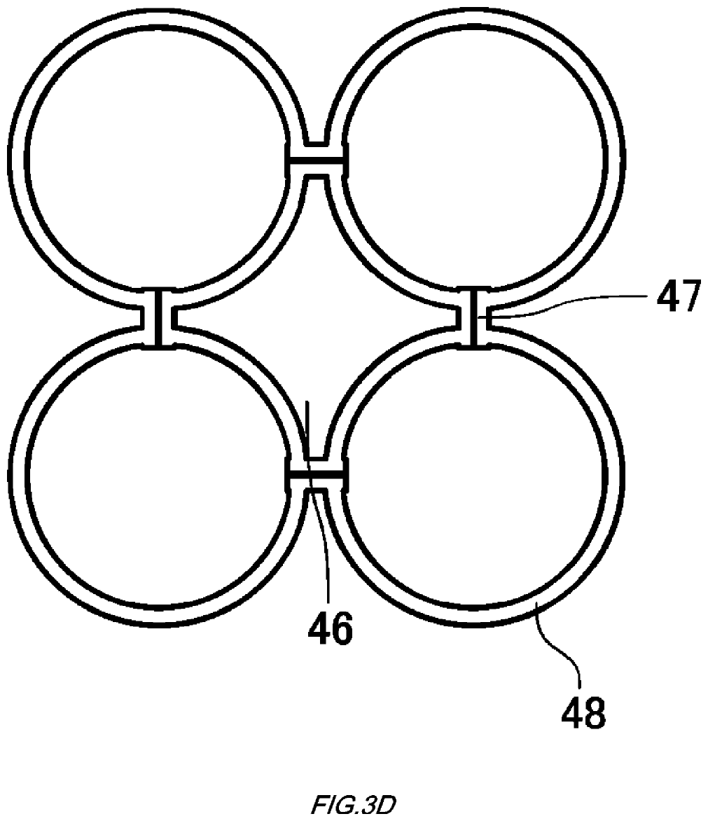

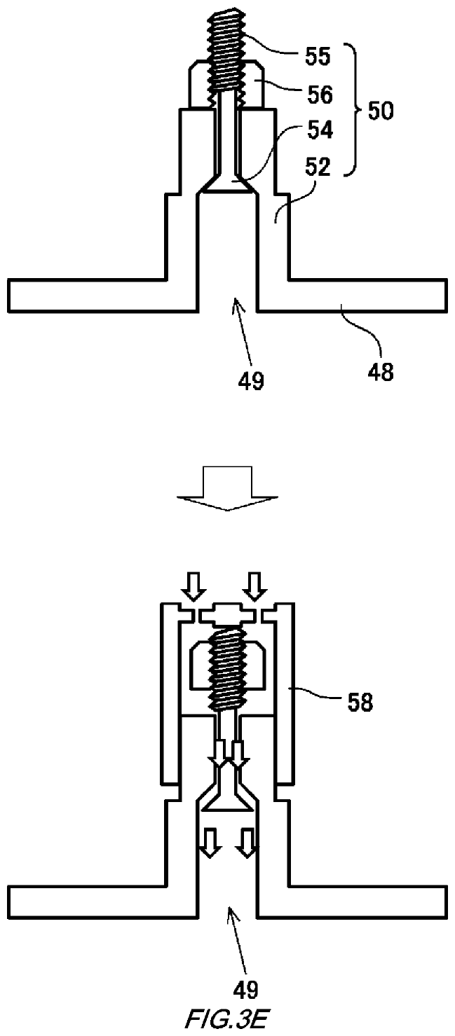

FIG. 3A illustrates an example of configurations of the unmanned aerial vehicle 100. The unmanned aerial vehicle 100 of the present example is the same as the example of FIG. 1A except for the configuration of the coupling unit 40. The coupling unit 40 of the present example has a buffering unit 42 including: a tube 46 for supplying a liquid from the container 70 to the discharging unit 60; and a supporting unit 48 for supporting the tube 46. FIG. 3B is an enlarged perspective view illustrating the structure of the buffering unit 42.

One end of the tube 46 is connected to the container 70, and the other end is connected to the discharging unit 60. The tube 46 is cylindrical, the inside of which is hollow, and can distribute a liquid. The tube 46 is extended in a discharge direction in which discharge of a liquid is desired, so that the discharging unit 60 connected to the end heads toward the discharge direction. The tube 46 may be extended by the supporting force from the supporting unit 48. The tube 46 may be made of soft material and may not be extended in the discharge direction when the tube 46 is in a state where the supporting unit 48 does not have the supporting force. For example, when the tube 46 is in a state where the supporting unit 48 does not have the supporting force, the tube 46 may hang down with gravity or may be rolled up to be held in the body 10.

The supporting unit 48 may be a member in a balloon shape made of stretch material such as rubber or vinyl, and is allowed to expand by tension on the surface caused by a filler supplied inside. In addition, the supporting unit 48 may be made of material having flexibleness. For example, the supporting unit 48 may be constructed from a metal thin film such as aluminium foil, a simple substance such as olefin, nylon, and polyester, or a laminate including them. The supporting unit 48 in an expanding state supports the tube 46 so as to cause the tube 46 to be extended. For example, the supporting unit 48 expands by encapsulating gas such as air to acquire supporting force for the tube 46. The volume of gas supplied to the supporting unit 48 may be adjusted in a range that the supporting unit 48 sustains the supporting force for the tube 46 and can deform in correspondence to the stress exceeding a predetermined threshold.

When the tube 46 is in an extending state by the supporting force from the supporting unit 48, for example, if the discharging unit 60 contacts with an obstacle during the flight of the unmanned aerial vehicle 100, the buffering unit 42 can buffer the stress because of the contact by deforming. In the present example, because the buffering unit 42 is provided over the entire coupling unit 40, the area that can deform is large, which can improve the effect of the stress buffering.

At least one supporting unit 48 is provided along the side of the tube 46. Although two supporting units 48 are joined above and below the tube 46 in the present example, the number of the supporting units 48 is not limited thereto. For example, FIG. 3C illustrates a case where the supporting unit 48 is one, as an example. The tube 46 and the supporting unit 48 may be made of the same material. In addition, as illustrated in FIG. 3D, the tube 46 may also be constructed by the sidewall of the supporting unit 48.

FIG. 3D illustrates an example of the tube 46 constructed by sidewalls of the supporting units 48. Note that the present drawing illustrates the cross section in a direction perpendicular to the extending direction of the tube 46 and the supporting unit 48. In the present example, four supporting units 48 are provided and sidewalls of adjacent supporting units 48 are joined together. Thus, the space enclosed by sidewalls of these supporting units 48 can be used as the tube 46 where a liquid is distributed. As illustrated in the drawing, the tube 46 and the supporting units 48 may be constructed by forming each of the inner side portions of the supporting units 48 (a portion constructing the tube 46) and each of the external side portions (the remaining portion) as a single member, sticking them together, and sealing the sticking portions by a sealing unit 47. The sealing unit 47 may be a joint by means of glue, welding, heat welding, or the like.

FIG. 3E illustrates an example of the inlet 49 configured to inject gas into the supporting unit 48. The inlet 49 is an aperture provided on the sidewall of the supporting unit 48. The inlet 49 may be provided at any position in the supporting unit 48. In the present example, a valve mechanism 50 for opening and closing the inlet 49 is provided. The valve mechanism 50 includes a stem 52 connected to the inlet 49, a plunger 54 which can seal the aperture of the stem 52, a screw 55 provided on the upper end of the plunger 54, and a nut 56 into which the screw 55 is screwed.

If the nut 56 is rotated and loosen from the state of the plunger 54 sealing the aperture of the stem 52, then the plunger 54 moves downward, and a gap between the stem 52 and the plunger 54 is generated. Gas can be supplied inside the supporting unit 48 through this gap. For example, a gas injecting nozzle 58 connected to a pump is connected to the stem 52 so that the gas transmitted from the pump can be supplied to the supporting unit 48. After completing gas supplying, the gas injecting nozzle 58 is removed and the nut 56 is tightened so that the plunger 54 seals the aperture of the stem 52 again, and the supporting unit 48 is airtightly sealed. Thus, for example, even when the unmanned aerial vehicle 100 flies for a long time, a gas leak from the supporting unit 48 can be prevented, and the pressure of the supporting unit 48 can be sustained.

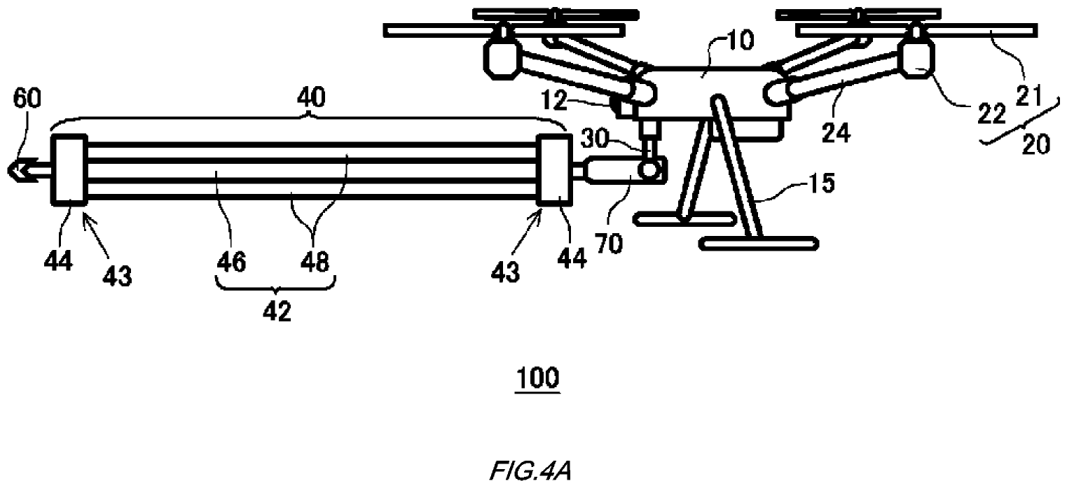

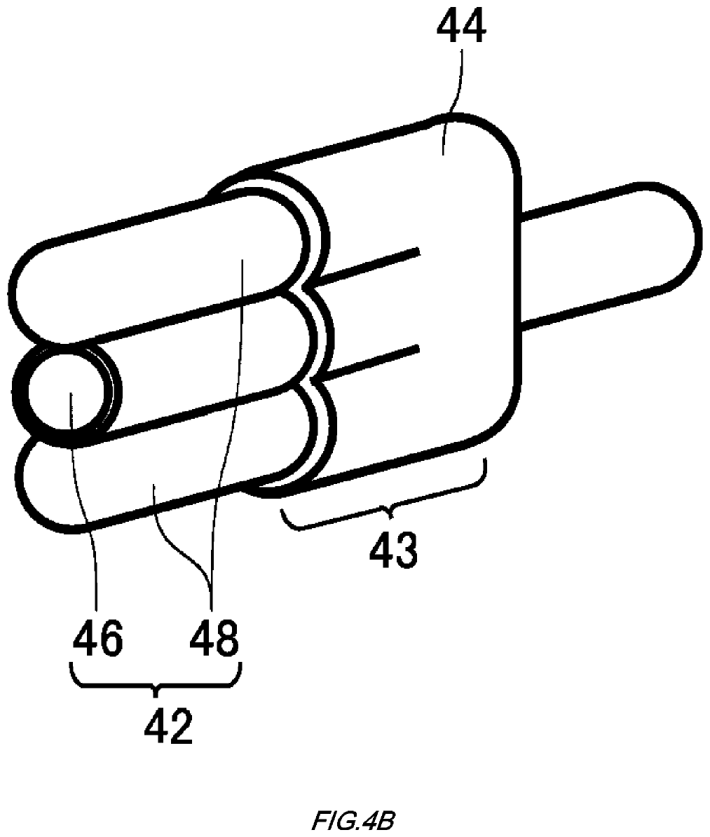

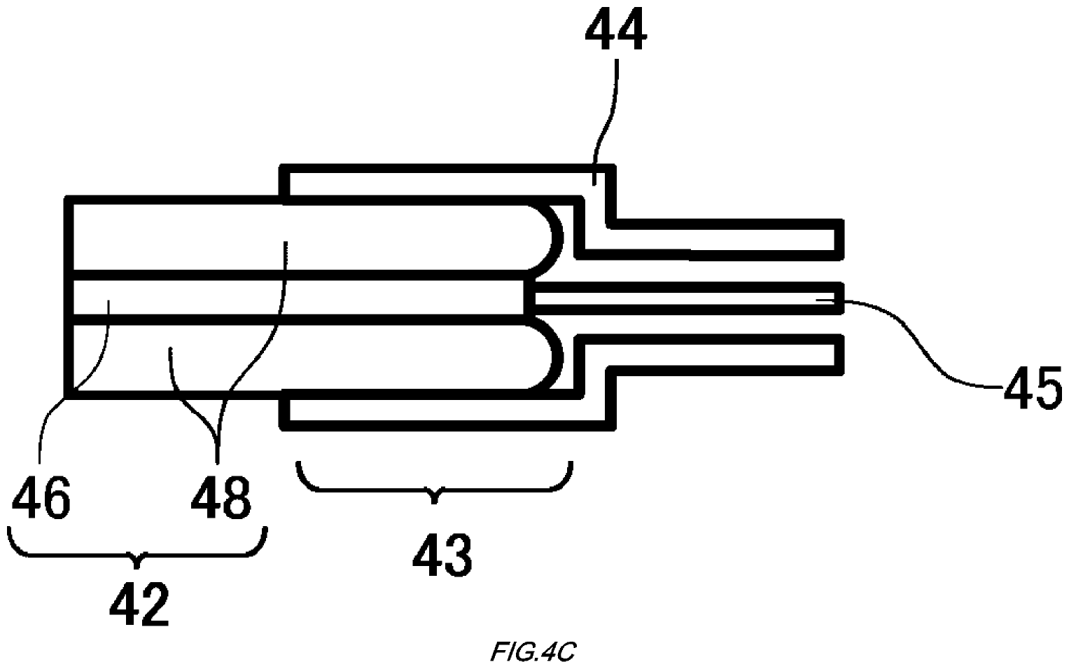

FIG. 4A illustrates an example of configurations of the unmanned aerial vehicle 100. The unmanned aerial vehicle 100 of the present example is the same as the example in FIG. 1A except for the configuration of the coupling unit 40. The coupling unit 40 of the present example includes: the buffering unit 42 including the tube 46 and the supporting unit 48 same as those of the example in FIG. 3A; and a rigid unit 44 coupled to the buffering unit 42.

In the coupling unit 40 of the present example, the buffering unit 42 is longer than the rigid unit 44. Note that the dimension of the coupling unit 40 in the extending direction is referred to as a length of the coupling unit 40 in this specification. In addition, the length of the longer one of the tube 46 or the supporting unit 48 is considered as the length of the buffering unit 42. In the present example, two rigid units 44 are provided, which are a rigid unit 44 between the buffering unit 42 and the container 70, and a rigid unit 44 between the buffering unit 42 and the discharging unit 60. In this case, the length of the buffering unit 42 is greater than the total lengths of the two rigid units 44. The buffering unit 42 is longer than the rigid unit 44, which causes the area possible to deform in the coupling unit 40 to be larger and improves the effect of the stress buffering.

FIG. 4B is an enlarged perspective view of the vicinity of the connecting unit 43, and FIG. 4C is an enlarged cross sectional view of the vicinity of the connecting unit 43. In the present example, the rigid unit 44 has a shape along the outward appearances of the tube 46 and the supporting unit 48 of the buffering unit 42. By pushing the tube 46 and the supporting unit 48 into the rigid unit 44, the buffering unit 42 and the rigid unit 44 are coupled together. In other words, in the connecting unit 43 of the present example, the buffering unit 42 is inserted into the rigid unit 44. Note that although the connecting unit 43 between the rigid unit 44 on the container 70 side and the buffering unit 42 are illustrated in FIG. 4B and FIG. 4C, the connecting unit 43 between the rigid unit 44 on the discharging unit 60 side and the buffering unit 42 may have the similar structure.

As illustrated in FIG. 4C, an internal stream tube 45 configured to distribute a liquid inside the coupling unit 40 may be provided. The internal stream tube 45 in the present example has one end connected to the container 70 and the other end connected to the tube 46 so as to distribute a liquid from the container 70 to the tube 46, inside the rigid unit 44. Note that, without providing the internal stream tube 45, the rigid unit 44 itself may be used as a flow channel of a liquid.

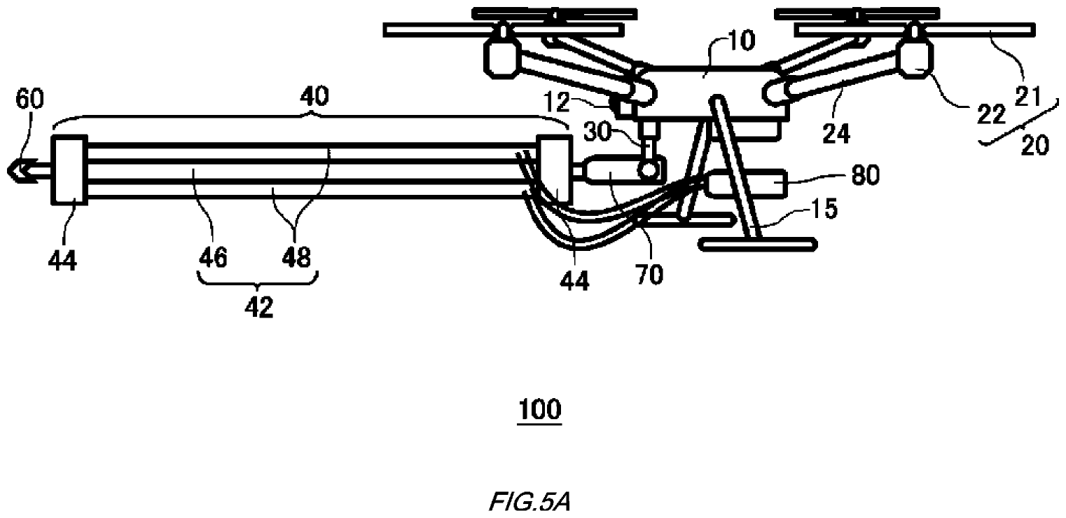

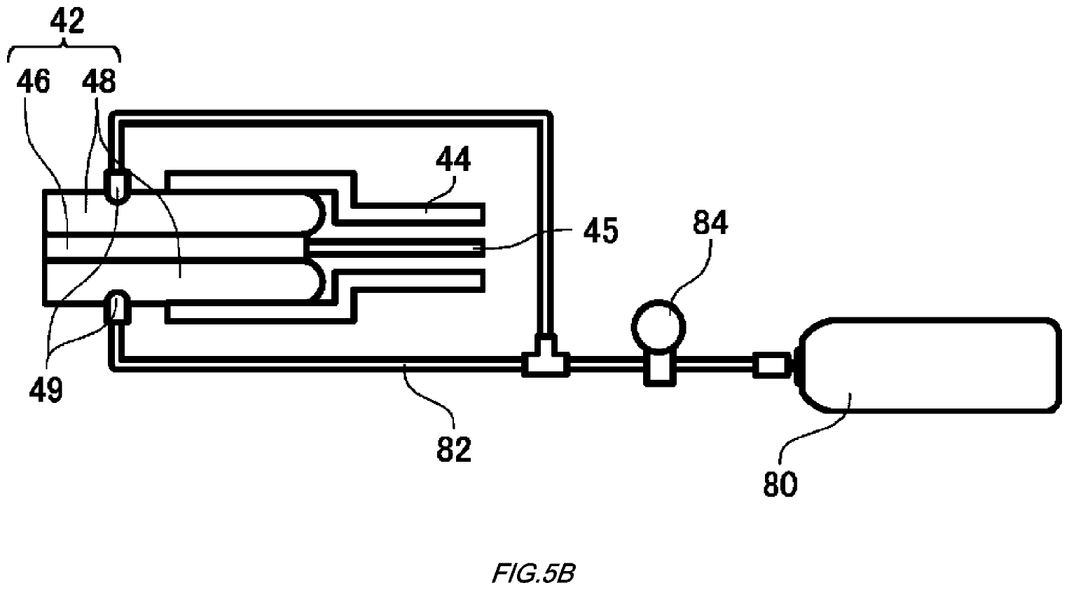

FIG. 5A illustrates an example of configurations of the unmanned aerial vehicle 100. The unmanned aerial vehicle 100 of the present example further includes a gas supplying unit 80, and other configurations are the same as the example illustrated in FIG. 4A. The gas supplying unit 80 is configured to maintain the pressure of the supporting unit 48 by supplying gas to the supporting unit 48. For example, as described above, the gas supplying unit 80 maintains the pressure of the supporting unit 48 in a range that the supporting unit 48 sustains the supporting force for the tube 46 and can deform in correspondence to the stress exceeding a predetermined threshold.

FIG. 5B is an enlarged cross sectional view of the vicinity of the gas supplying unit 80. The gas supplying unit 80 may be an aerosol container configured to eject a gas by by a gas pressure of liquefied gas or compressed gas filling the inside. The gas supplying unit 80 is connected to the inlet 49 of the supporting unit 48 by a gas supplying tube 82. The gas supplying tube 82 is provided with a gas supply controller 84. The gas supply controller 84, for example, has an electromagnetic valve, and opens and closes the gas supplying tube 82. In response to the gas supplying tube 82 opening, the gas discharged from the gas supplying unit 80 is supplied to the supporting unit 48. The gas supply controller 84 may include a pressure sensor configured to sense the pressure of the supporting unit 48, and in accordance with the sensed pressure, may open and close the gas supplying tube 82. For example, if the pressure of the supporting unit 48 is below a predetermined threshold, the gas supply controller 84 opens the gas supplying tube 82, so that gas is supplied to the supporting unit 48 from the gas supplying unit 80, and a pressure is applied on the supporting unit 48.

In this manner, by providing the gas supplying unit 80, the pressure of the supporting unit 48 can appropriately be maintained during the flight of the unmanned aerial vehicle 100. Therefore, for example, even when a gas leak from the supporting unit 48 occurs, or even when the pressure of the supporting unit 48 is changed due to the fluctuation of the outside pressure during the flight, the effect of the stress buffering can be maintained while sustaining the extending state of the buffering unit 42.

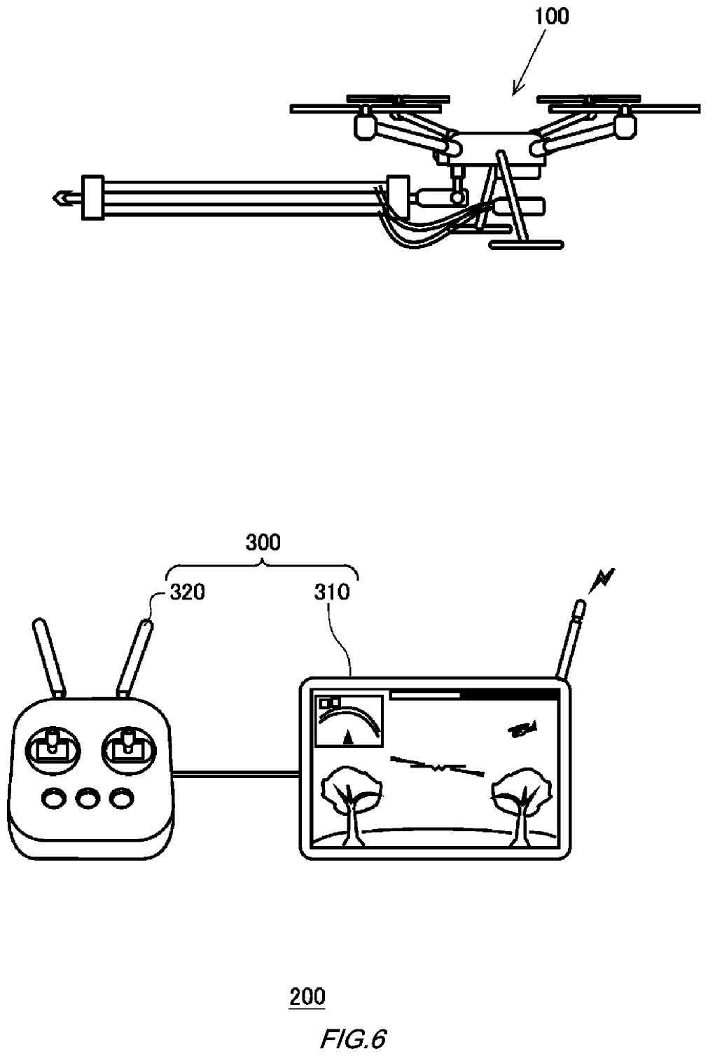

FIG. 6 illustrates an example of a piloting system 200 of an unmanned aerial vehicle 100. The piloting system 200 of the present example includes the unmanned aerial vehicle 100 and a terminal apparatus 300. The terminal apparatus 300 includes a display 310 and a controller 320.

The display 310 is configured to display a video captured by a camera 12. When the camera 12 includes a fixed camera and a movable camera, the display 310 may display videos captured by each camera. For example, the display 310 displays videos of the fixed camera and the movable camera in a divided screen. The display 310 may directly communicate with the unmanned aerial vehicle 100, or may indirectly communicate with the unmanned aerial vehicle 100 via the controller 320. The display 310 may be connected to an external server.

The controller 320 is operated by a user and configured to pilot the unmanned aerial vehicle 100. The controller 320 may instruct the discharge of a liquid by a discharging unit 60 in addition to the flight of the unmanned aerial vehicle 100. The controller 320 may be connected to the display 310 by wired connection or wirelessly. A plurality of controllers 320 may be provided to be used properly for piloting the unmanned aerial vehicle 100 and controlling the discharge of a liquid. In addition, the controller 320 may instruct the gas supply controller 84 to supply gas from the gas supplying unit 80 to the supporting unit 48.

Note that, the unmanned aerial vehicle 100 of the present example is piloted manually by using the terminal apparatus 300. However, the unmanned aerial vehicle 100 may be piloted not manually but automatically by a program. The user may also directly look at and pilot the unmanned aerial vehicle 100 without using the screen displayed by the display 310. In addition, piloting the unmanned aerial vehicle 100 may be automatically controlled, and discharging a liquid may be manually operated.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCES

10: body, 15: leg, 20: propelling unit, 21: rotor wing, 22: rotation driving unit, 24: arm, 30: container retaining unit, 40: coupling unit, 42: buffering unit, 43: connecting unit, 44: rigid unit, 45: internal stream tube, 46: tube, 47: sealing unit, 48: supporting unit, 49: inlet, 50: valve mechanism, 52: stem, 54: plunger, 55: screw, 56: nut, 58: gas injecting nozzle, 60: discharging unit, 70: container, 80: gas supplying unit, 82: gas supplying tube, 84: gas supply controller, 100: unmanned aerial vehicle, 200: piloting system, 300: terminal apparatus, 310: display, 320: controller

1. An unmanned aerial vehicle configured to be able to discharge a liquid, comprising:
a container of the liquid;
a discharging unit configured to discharge the liquid; and
a coupling unit configured to couple the container and the discharging unit together, wherein the coupling unit includes a buffering unit configured to buffer stress generated in the coupling unit.

2. The unmanned aerial vehicle according to claim 1, wherein the container is an aerosol container.

3. The unmanned aerial vehicle according to claim 1, wherein the coupling unit includes a rigid unit coupled to the buffering unit and configured to have rigidity higher than the buffering unit.

4. The unmanned aerial vehicle according to claim 3, wherein the buffering unit is longer than the rigid unit, in the coupling unit.

5. The unmanned aerial vehicle according to claim 3, comprising a connecting unit in which one of the buffering unit and the rigid unit is inserted into the other of the buffering unit and the rigid unit.

6. The unmanned aerial vehicle according to claim 3, wherein the buffering unit is provided closer to the container than the rigid unit, in the coupling unit.

7. The unmanned aerial vehicle according to claim 3, wherein the buffering unit is provided closer to the discharging unit than the rigid unit, in the coupling unit.

8. The unmanned aerial vehicle according to claim 1, wherein the buffering unit includes:
a tube configured to supply the liquid from the container to the discharging unit; and
a supporting unit configured to support the tube.

9. The unmanned aerial vehicle according to claim 8, wherein the supporting unit includes an inlet configured to inject a gas and is configured to acquire a supporting force for the tube by encapsulating the gas.

10. The unmanned aerial vehicle according to claim 8, further comprising a gas supplying unit for supplying a gas to the supporting unit, wherein the gas supplying unit is configured to maintain a pressure of the supporting unit.

11. The unmanned aerial vehicle according to claim 10, wherein the gas supplying unit is an aerosol container.

12. The unmanned aerial vehicle according to claim 8, wherein the tube is configured to be extended by a supporting force from the supporting unit.

13. The unmanned aerial vehicle according to claim 8, wherein at least one of the supporting units is provided along a side of the tube.

14. The unmanned aerial vehicle according to claim 8, wherein the tube is constructed by a sidewall of the supporting unit.

15. The unmanned aerial vehicle according to claim 2, wherein the coupling unit includes a rigid unit coupled to the buffering unit and configured to have rigidity higher than the buffering unit.

16. The unmanned aerial vehicle according to claim 4, comprising a connecting unit in which one of the buffering unit and the rigid unit is inserted into the other of the buffering unit and the rigid unit.

17. The unmanned aerial vehicle according to claim 2, wherein the buffering unit includes:
a tube configured to supply the liquid from the container to the discharging unit; and
a supporting unit configured to support the tube.

18. The unmanned aerial vehicle according to claim 3, wherein the buffering unit includes:
a tube configured to supply the liquid from the container to the discharging unit; and
a supporting unit configured to support the tube.

19. The unmanned aerial vehicle according to claim 5, wherein the buffering unit includes:
a tube configured to supply the liquid from the container to the discharging unit; and
a supporting unit configured to support the tube.

20. The unmanned aerial vehicle according to claim 9, further comprising a gas supplying unit for supplying a gas to the supporting unit, wherein the gas supplying unit is configured to maintain a pressure of the supporting unit.
